(19) United States
(12) Patent Application Publication
(10) Pub. No.: US 2023/0400641 A1
(43) Pub. Date: Dec. 14, 2023

(54) OPTICAL CONNECTION DEVICE, COMPOSITE OPTICAL CONNECTION DEVICE, AND MANUFACTURING METHOD OF OPTICAL CONNECTION DEVICE

(71) Applicant: NEC Corporation, Tokyo (JP)

(72) Inventor: Takenao YOKOMORI, Tokyo (JP)

(73) Assignee: NEC Corporation, Tokyo (JP)

(21) Appl. No.: 18/205,017

(22) Filed: Jun. 2, 2023

(30) Foreign Application Priority Data
Jun. 10, 2022 (JP) 2022-094423

(51) Int. Cl. G02B 6/38

(52) U.S. Cl. CPC G02B 6/3829

(57) ABSTRACT

An optical connection device includes a first optical component having a first optical axis, a second optical component having a second optical axis different from the first optical axis, and a silicon optical waveguide module that includes a silicon optical waveguide having a bending shape for changing a direction of the first optical axis to a direction of the second optical axis and is connected to each of the first optical component and the second optical component.

This application is based upon and claims the benefit of priority from Japanese Patent Application No. 2022-094423, filed on Jun. 10, 2022, the disclosure of which is incorporated herein in its entirety by reference.

### TECHNICAL FIELD

The present disclosure relates to an optical connection device and the like.

### BACKGROUND ART

An optical connection device such as an optical connector and an optical adapter is used as an interface between an optical transmission device and an optical fiber. A general optical transmission device includes an optical receptacle on a side surface vertical to a horizontal plane (for example, a front plate of the device). An optical connector attached to a distal end of the optical fiber is connected to the optical receptacle, and thus the optical fiber is connected to the optical transmission device via the optical connector and the optical receptacle.

In relation to the present disclosure, Patent Literature (PTL) 1 describes an optical device including a mirror for changing a direction of light propagated between an optical fiber and a grating (diffraction grating). Further, Patent Literature 2 describes a technique of forming a three-dimensional curved optical waveguide.
[PTL 1] Japanese Unexamined Patent Application Publication (Translation of PCT Application) No. 2017-516150
[PTL 2] International Patent Publication WO2017/145706

### SUMMARY

In general, an optical fiber including an optical connector attached to one end thereof is also referred to as a pig-tail cord. The pig-tail cord is a type of an optical connection device. The pig-tail cord has a structure in which a core wire of the optical fiber is inserted into a center of a ferrule of the optical connector. Thus, the optical fiber of the pig-tail cord connected to an optical receptacle installed on a vertical surface is oriented in a horizontal direction in the vicinity of the optical connector in a manner similar to the ferrule. Therefore, when the optical fiber of the pig-tail cord into which the optical connector is inserted in the horizontal direction is oriented in a vertical direction (for example, downward toward a horizontal plane), an accommodation space for the optical fiber, which is equivalent to a bending radius of the optical fiber, is required in the horizontal direction. A minimum bending radius allowed in a general quartz optical fiber is approximately 30 mm. The accommodation space for the optical fiber is occupied with the optical fiber, and hence it is required to secure a floor area for the accommodation space for the optical fiber at a time of connecting the general pig-tail cord to an optical transmission device. In other words, the general pig-tail cord has a problem that a space required for handling is large due to a restriction of the bending radius of the optical fiber. Thus, there is a problem that it is difficult to reduce a size of the optical connector that enables input and output of light in a direction different from an optical axis of the ferrule (hereinafter, referred to as an “optical angle connector”).

An exemplary object of the disclosure is to provide a technique for achieving a small-sized optical angle connector.

An optical connection device according to the present disclosure includes:
a first optical component having a first optical axis;
a second optical component having a second optical axis different from the first optical axis; and
a silicon optical waveguide module including a silicon optical waveguide having a bending shape for changing a direction of the first optical axis to a direction of the second optical axis, and being connected to each of the first optical component and the second optical component.

A manufacturing method of an optical connection device according to the present disclosure includes a procedure of
connecting, to each one of a first optical component having a first optical axis and a second optical component having a second optical axis different from the first optical axis, a silicon optical waveguide module including a silicon optical waveguide having a bending shape for changing a direction of the first optical axis to a direction of the second optical axis.

### BRIEF DESCRIPTION OF THE DRAWINGS

Exemplary features and advantages of the present disclosure will become apparent from the following detailed description when taken with the accompanying drawings in which:

FIG. 1 is a diagram for describing a configuration example of an optical connection device according to a first example embodiment;

FIG. 2 is a diagram for describing a configuration example of an optical waveguide module;

FIG. 3 is a diagram for describing a configuration example of the optical waveguide module;

FIG. 4 is a diagram for describing another example of the optical connection device;

FIG. 5 is a diagram for describing a first modification example of the first example embodiment;

FIG. 6 is a diagram for describing a second modification example of the first example embodiment;

FIG. 7 is a diagram for describing a third modification example of the first example embodiment;

FIG. 8 is a diagram for describing a configuration example of an optical connection device according to a second example embodiment;

FIG. 9 is a diagram for describing a configuration example of an optical waveguide module;

FIG. 10 is a diagram for describing a modification example of the second example embodiment;

FIG. 11 is a diagram for describing a configuration example of an optical connection device according to a third example embodiment;

FIG. 12 is a diagram for describing a first modification example of the third example embodiment;

FIG. 13 is a diagram for describing a second modification example of the third example embodiment;

FIG. 14 is a diagram for describing a configuration example of an optical connection device according to a fourth example embodiment;

FIG. 15 is a diagram for describing a configuration example of an optical connection device according to a fifth example embodiment;

FIG. 16 is a diagram for describing a modification example of the fifth example embodiment; and

FIG. 17 is a diagram for describing an application example of the optical connection device according to the fifth example embodiment.

### EXAMPLE EMBODIMENT

Next, a detailed explanation will be given for a first example embodiment with reference to the drawings.

In each of the example embodiments, elements that are previously described are denoted with the identical names and the identical reference symbols, and overlapping description therefor is omitted as appropriate. Further, the drawings are schematic diagrams for describing the example embodiments, and description such as a cross-sectional view is simplified.

### First Example Embodiment

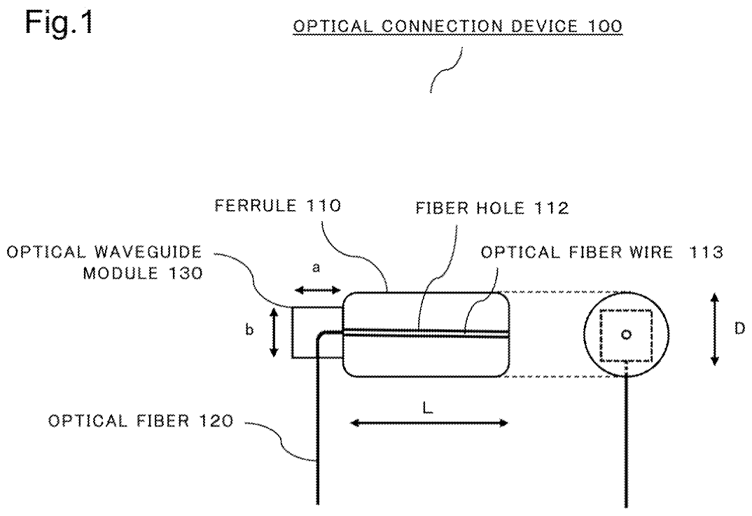

FIG. 1 is a diagram for describing a configuration example of an optical connection device 100 according to the first example embodiment. The optical connection device 100 is a pig-tail cord including a ferrule 110, an optical fiber 120, and an optical waveguide module 130. The ferrule 110 is a known component that is formed of ceramic or the like and has a cylindrical shape, and has a fiber hole 112 at the center in the lengthwise direction in which an optical fiber wire (bare fiber) 113 is embedded. Both the ends of the optical fiber wire 113 arrive at two side surfaces of the ferrule 110. Thus, both the ends of the ferrule 110 can be connected optically to another optical component (an optical fiber wire, an optical waveguide).

The optical waveguide module 130 is an optical waveguide element including a silicon substrate, and can be connected optically to another optical component at both the ends of the optical waveguide.

The optical fiber 120 is a general quartz glass optical fiber, and is a single-mode optical fiber (SMF) having a core diameter of approximately 9 to 10 μm or a multi-mode optical fiber (MMF) having a core diameter of approximately 50 to 60 μm, for example.

An end surface of the ferrule 110 to which the optical waveguide module 130 is not connected can be connected optically to a ferrule of another optical connector. In other words, the ferrule 110 and the end surface of the other optical connector abut against each other, and thus the other optical connector and the optical fiber 120 can be connected optically to each other. An optical adapter or a split sleeve may be used for connection between the ferrule 110 and the other optical connector.

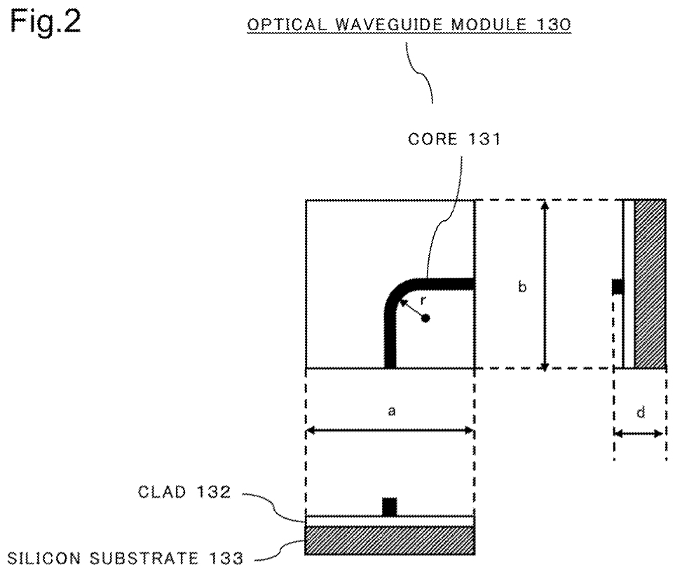

FIG. 2 is a diagram for describing a configuration example of the optical waveguide module 130. The optical waveguide module 130 includes a core 131 that has two ends and a clad 132 that is brought into contact with the core 131. The core 131 and the clad 132 form a silicon optical waveguide on a silicon substrate 133. The core 131 has a bending shape, and changes a direction of an optical axis of light that is input from one end of the core 131. The silicon optical waveguide that is formed by the core 131 formed of silicon and the clad 132 formed of silicon dioxide is capable of bending a propagation direction of light with a relatively low loss even when the diameter has a curvature of several tens of micrometers. Thus, the silicon optical waveguide is widely used as a function component of an optical transceiver or the like that is required to be reduced in size.

For example, the optical waveguide module 130 having a function of bending the light propagation direction at 90 degrees can be achieved by forming the core 131 having an arc portion with a bending radius r of 50 μm or smaller. In this case, the optical waveguide module 130 may be a rectangular parallelepiped shape having a side of 1 mm or smaller. Further, each of the sides a and b and the thickness d of the optical waveguide module 130 described above can sufficiently be reduced to be smaller than a diameter D (for example, 1.25 mm) of a ferrule of an LC connector or an MU connector in general. Thus, the optical waveguide module 130 is used, and thus the light propagation direction can be changed at a curvature much smaller than a bending radius of an optical fiber, which is generally required to be several tens of millimeters or larger. In other words, the optical waveguide module 130 is capable of connecting the ferrule 110 having the first optical axis and the optical fiber 120 having the second optical axis different from the first optical axis, to each other. Therefore, in the optical connection device 100, the optical fiber 120 can be connected from the vicinity of the ferrule 110 to the direction different from the optical axis of the ferrule 110 (downward at the right angles in FIG. 1). The optical connection device 100 described above is one mode of a small-sized optical angle connector.

The connection portion between the ferrule 110 and the optical waveguide module 130, and the connection portion between the optical fiber 120 and the optical waveguide module 130 may each be fixed after optical axis adjustment therebetween. An adhesive formed of a thermosetting resin or an ultraviolet light curable resin as a material is used for fixation of the connection portions, for example.

A lens may be included in at least one of a first position and a second position, where the first position is between the ferrule 110 and the optical waveguide module 130, and the second position is between the optical fiber 120 and the optical waveguide module 130. Even when a numerical aperture (NA) of the ferrule 110 or the optical fiber 120 and a numerical aperture of the core 131 are different from each other, for example, an increase of a connection loss therebetween can be suppressed by using the lens.

The optical connection device described in FIG. 1 may be described as follows while denoting the reference symbols in the parentheses. In other words, an optical connection device (100) includes a first optical component (110), a second optical component (120), and a silicon optical waveguide module (130). The ferrule 110 is an example of the first optical component (110), and the optical fiber 120 is an example of the second optical component (120). Further, the optical waveguide module 130 is an example of the silicon optical waveguide module (130). The first optical component (110) has a first optical axis, and the second optical component (120) has a second optical axis different from the first optical axis. The silicon optical waveguide module (130) includes a silicon optical waveguide that has a bending shape for changing a direction of the first optical axis to a direction of the second optical axis, and connects the first optical component (110) and the second optical component (120) to each other.

With the optical connection device 100 thus configured, a small-sized optical angle connector can be achieved. The reason for this is because the bending portion of light can be reduced in size by using the silicon optical waveguide for the bending portion of the optical transmission path.

Further, in the silicon optical waveguide module (130), one end of the silicon optical waveguide and the first optical axis may be fixed to each other under an optically coupled state. Further, the other end of the silicon optical waveguide and the second optical axis may be fixed to each other under an optically coupled state.

### (Modification Example of Optical Waveguide Module)

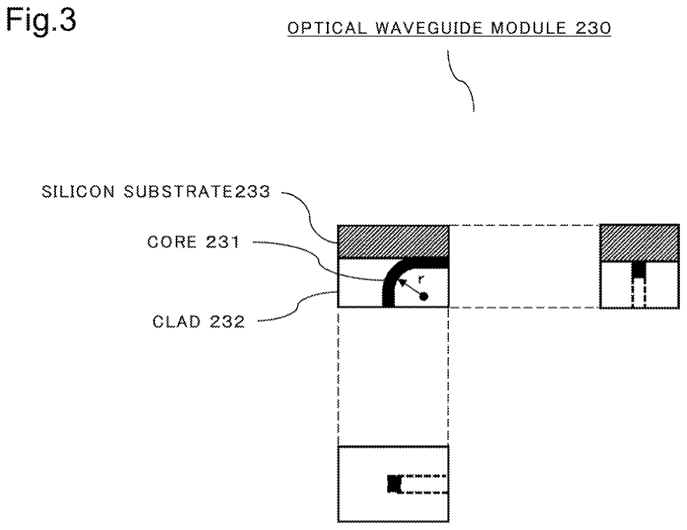

FIG. 3 is a diagram for describing a modification example of the optical waveguide module 130. An optical waveguide module 230 illustrated in FIG. 3 is used in place of the optical waveguide module 130 of the optical connection device 100. The optical waveguide module 230 includes a core 231 and a clad 232. The core 231 has two ends, and is formed of silicon. The clad 232 is formed of silicon dioxide.

A part of the core 231 is formed to contact with a silicon substrate 233. Further, the core 231 is curved with the radius r in a direction vertical to the silicon substrate 233 from the middle of the core 231 in the longitudinal direction. A manufacturing method of the curved core described above is described in PTL 2. The clad 232 may be formed in such a way to cover the core 231, including a part thereof away from the silicon substrate 233. The core 231 thus formed is also capable of bending a propagation direction of light with a relatively low loss even when the radius r has a curvature of several tens of micrometers.

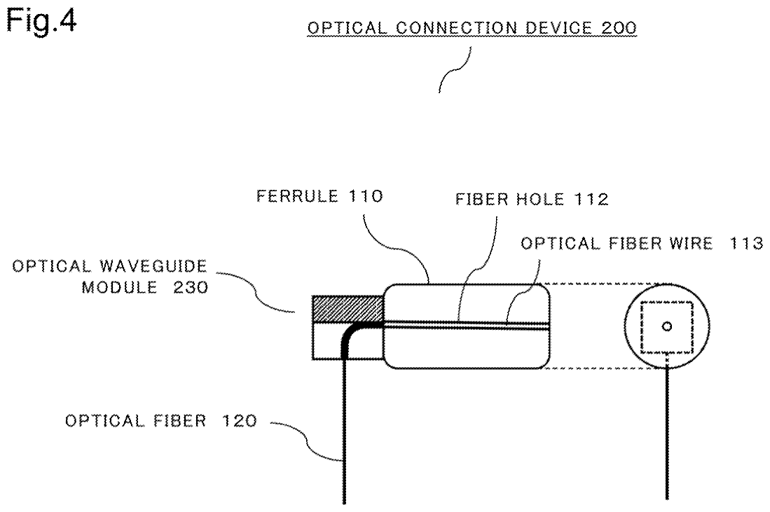

FIG. 4 is a diagram for describing a configuration example of an optical connection device 200 including the optical waveguide module 230. The optical connection device 200 is achieved by replacing the optical waveguide module 130 included in the optical connection device 100 with the optical waveguide module 230. The optical waveguide module 230 is capable of changing a direction of light propagated inside the core 231 being the silicon optical waveguide with a small bending radius. Therefore, with the optical connection device 200, a small-sized optical angle connector can also be achieved.

In FIG. 4, the end of the core 231 with which the silicon substrate 233 contacts is connected to the ferrule 110. Further, the end of the core 231, which is curved in the direction vertical to the silicon substrate 233, is connected to the optical fiber 120. However, the end of the core 231 with which the silicon substrate 233 contacts may be connected to the optical fiber 120, and the end thereof, which is curved in the direction vertical to the silicon substrate 233, may be connected to the ferrule 110.

In the following example embodiments and modification examples thereof, description is made on optical connection devices in which the optical waveguide module 130 exemplified in FIG. 2 and modification examples thereof are used. However, in each of the example embodiments, the optical waveguide module 230 exemplified in FIG. 3 may be used in place of the optical waveguide module 130 and the modification examples thereof. Even when the optical waveguide module 230 is used, the optical connection device according to each of the example embodiments exerts similar effects.

Further, the means for changing the propagation direction of the incident light is not limited to the curved core. As a technique of changing a light propagation direction by using a small-sized silicon optical waveguide, there has been known a technique in which a coupler using a grating (grating coupler) or a mirror is used. An optical function module using such techniques may be used in place of the optical waveguide modules 130 and 230.

### (First Modification Example of First Example Embodiment)

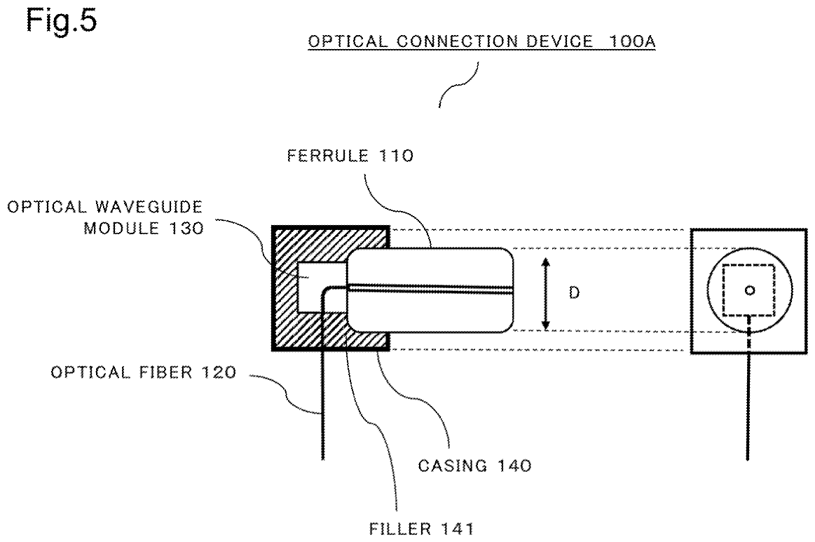

FIG. 5 is a diagram for describing a configuration example of an optical connection device 100A being a first modification example of the first example embodiment. FIG. 5 illustrates a cross-sectional view and a front view of the optical connection device 100A in association with each other. In the optical connection device 100A in FIG. 5, the ferrule 110, the optical fiber 120, and the optical waveguide module 130 are covered with one casing 140. The inside of the casing 140 is filled with a filler 141. The casing 140 may have a hole through which the filler is injected. The materials of the casing 140 and the filler 141 are not limited. For example, the casing 140 is formed of metal or plastic. The casing 140 is formed of a plurality of components, and may be assembled in such a way to cover the ferrule 110, the optical fiber 120, and the optical waveguide module 130. the filler 141 is, for example, a thermosetting resin or an ultraviolet light curable resin. As the filler 141, an adhesive used for fixing the optical axis of the optical waveguide module 130 may be used. In other words, the casing 140 may be attached in such a way to cover the optical waveguide module 130 after optical axis adjustment between the optical waveguide module 130 and the ferrule 110 and optical axis adjustment between the optical waveguide module 130 and the optical fiber 120. Further, after the casing 140 is attached, the inside thereof may be filled with the adhesive as the filler 141.

The optical waveguide module 130 is formed of silicon as a material, and hence one side thereof may be smaller than the diameter D of the ferrule 110. Thus, the outer shape dimension of the casing 140 is sufficient enough to cover the ferrule 110. For example, when the diameter of the ferrule 110 is 2 mm, the casing 140 may be formed into a cube having a side of 3 mm. In other words, with the optical connection device 100A, a small-sized optical angle connector can also be achieved.

With this structure, the optical connection device 100A can reduce a risk of damage or optical axis deviation due to an external force because the ferrule 110, the optical fiber 120, and the optical waveguide module 130 can firmly be integrated. As a result, with the optical connection device 100A, a small-sized optical angle connector can be achieved, and reliability of the optical connection device 100 can be improved at the same time.

### (Second Modification Example of First Example Embodiment)

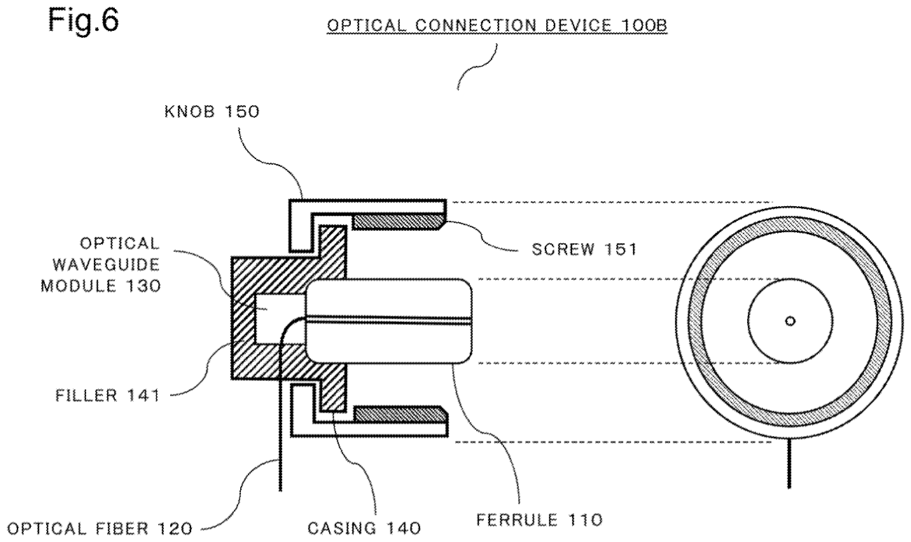

FIG. 6 is a diagram for describing a configuration example of an optical connection device 100B being a second modification example of the first example embodiment. In the optical connection device 100B, the ferrule 110, the optical fiber 120, and the optical waveguide module 130 are covered with the one casing 140. The inside of the casing 140 is filled with the filler 141.

The optical connection device 100B further includes a knob 150. A screw 151 is provided at the distal end of the knob 150. The screw 151 is engaged with a screw of an optical device (for example, an optical receptor) connected to the optical connection device 100B. The structure for connecting the optical connection device 100B to another optical device is not limited to a screw. For example, the optical connection device 100B may have a connecting structure provided to a general snap-on optical connector.

With this structure, the optical connection device 100B can firmly be connected to another optical device, and hence occurrence of a connection failure due to an external force after connection can be suppressed. As a result, with the optical connection device 100B, a small-sized optical angle connector having high connection reliability can be achieved.

### (Third Modification Example of First Example Embodiment)

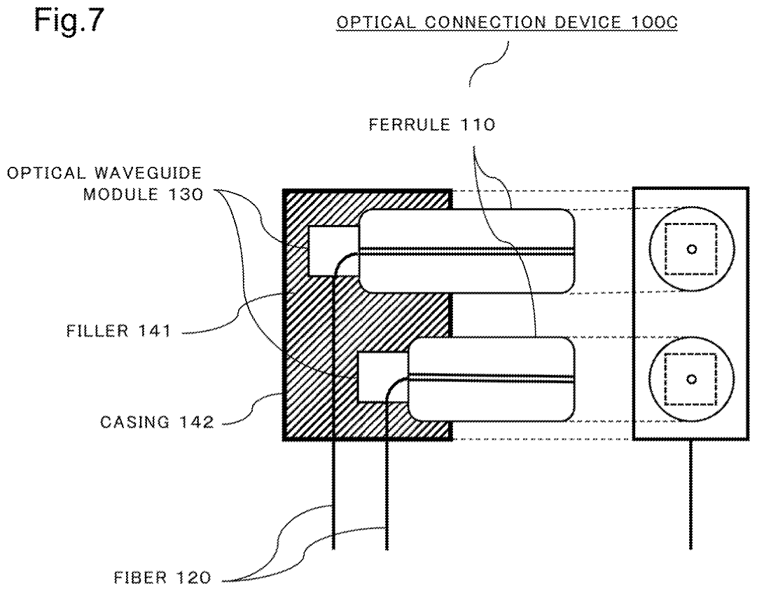

FIG. 7 is a diagram for describing a configuration example of optical connection device 100C being a third modification example of the first example embodiment. The optical connection device 100C has a structure in which two optical connection devices 100 described in FIG. 1 are stacked. The lengths of the ferrules of the two optical connection devices 100 may be different from each other. In other words, in the optical connection device 100C, the two ferrules 110, the two optical fibers 120, and the two optical waveguide modules 130 form the optical connection devices. Further, in the optical connection device 100C, those are covered with one casing 142. The inside of the casing 142 is filled with the filler 141.

With this structure, in the optical connection device 100C, for example, the two optical receptacles and the two optical fibers 120 that are arranged at a small interval can be connected to each other, and the optical fibers 120 can be arranged in the direction at the right angles with respect to the ferrules 110. In other words, in the optical connection device 100C, small-sized optical angle connectors can be arranged at high density.

### Second Example Embodiment

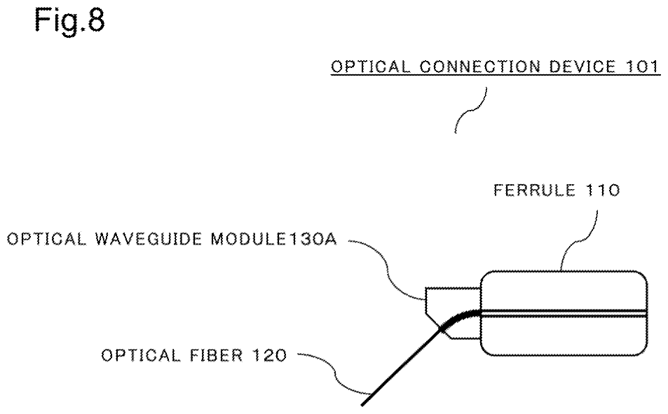

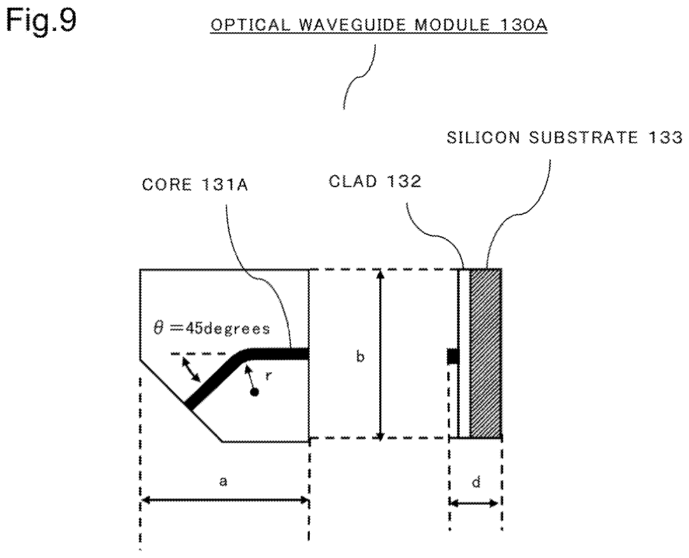

FIG. 8 is a diagram for describing a configuration example of an optical connection device 101 according to the second example embodiment. The optical connection device 101 includes the ferrule 110, the optical fiber 120, and an optical waveguide module 130A. FIG. 9 is a diagram for describing a configuration example of the optical waveguide module 130A.

The optical waveguide module 130A is modification example of the optical waveguide module 130. Similarly to the optical waveguide module 130, the optical waveguide module 130A is an optical waveguide element formed of silicon as a material, and can optically be connected to another optical component at both the ends of the optical waveguide. The optical waveguide module 130A includes a core 131A having two ends. The core 131A has a structure for bending the light propagation direction by 45 degrees by the curved line of the radius r (0=45 degrees in FIG. 9). Here, the bending angle θ indicates an angle formed between a propagation direction before bending the light propagated in the core 131A and a propagation direction after bending the light by the curved line of the radius r. The optical waveguide module 130A including the core 131A described above may also have a shape having sides a and b, and a thickness d that are 1 mm or smaller. Thus, the light propagation direction can be changed by 45 degrees at a curvature much smaller than a bending radius of a general optical fiber, by using the optical waveguide module 130A. In other words, in the optical connection device 101, the optical fiber 120 can be connected from the vicinity of the ferrule 110 to the direction of 45 degrees with respect to the optical axis of the ferrule 110 without largely affecting the dimension of the optical connector.

Similarly to the optical connection device 100, the connection portion between the ferrule 110 and the optical waveguide module 130A and the connection portion between the optical fiber 120 and the optical waveguide module 130A are both fixed after optical axis adjustment. An adhesive formed of, for example, a thermosetting resin or an ultraviolet light curable resin as a material is used for such fixing.

In FIG. 9, the bending angle θ of the core 131A is 45 degrees. However, the angle θ is not limited to 45 degrees. The bending angle θ of the core 131A in FIG. 9 may be one fixed angle of 35 degrees or larger and 100 degrees or smaller, for example. The optical waveguide module 130 illustrated in FIG. 2 is associated with a case of 0=90 degrees. By forming the core 131A having the bending angle θ according to the angle between the ferrule 110 and the optical fiber 120 that is required for the optical connection device 101, a small-sized optical angle connector suitable for an application can be achieved.

### (Modification Example of Second Example Embodiment)

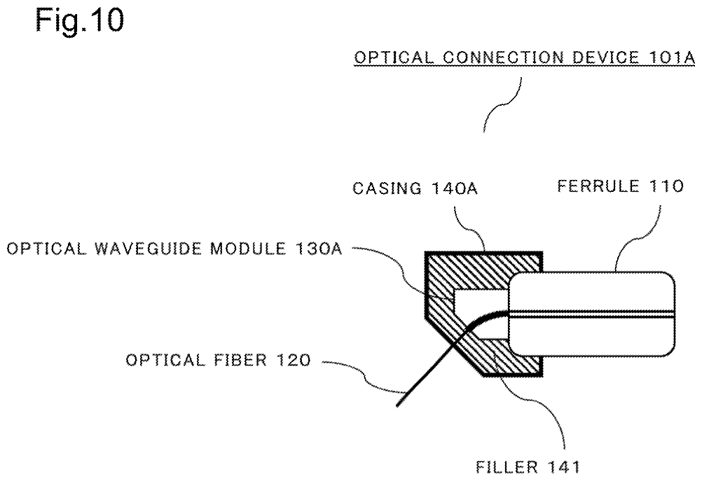

FIG. 10 is a diagram for describing a modification example of an optical connection device 101A being a modification example of the optical connection device 101 according to the second example embodiment. In the optical connection device 101A in FIG. 10, the ferrule 110, the optical fiber 120, and the optical waveguide module 130A are covered with the one casing 140A. The inside of the casing 140A is filled with the filler 141. The materials of the casing 140A and the filler 141A are not particularly limited. For example, the casing 140A is formed of metal or plastic. The filler 141A is, for example, a thermosetting resin or an ultraviolet light curable resin. As the filler 141, an adhesive used for fixing the optical axis of the optical waveguide module 130A may be used. In other words, the casing 140A may be attached in such a way to cover the optical waveguide module 130A after optical axis adjustment between the optical waveguide module 130A and the ferrule 110 and optical axis adjustment between the optical waveguide module 130A and the optical fiber 120. Further, after the casing 140A is attached, the inside thereof may be filled with the adhesive as the filler 141.

With this structure, the optical connection device 101A can reduce a risk of damage or optical axis deviation due to an external force because the ferrule 110, the optical fiber 120, and the optical waveguide module 130A can firmly be integrated. As a result, the optical connection device 101A can improve reliability of the optical connection device 101. Further, with the optical connection device IOTA, a small-sized optical angle connector can also be achieved.

Further, similarly to the optical connection device 100B in the second modification example of the first example embodiment, the optical connection device IOTA may also has a configuration for engagement with another optical device (for example, an optical receptacle).

### Third Example Embodiment

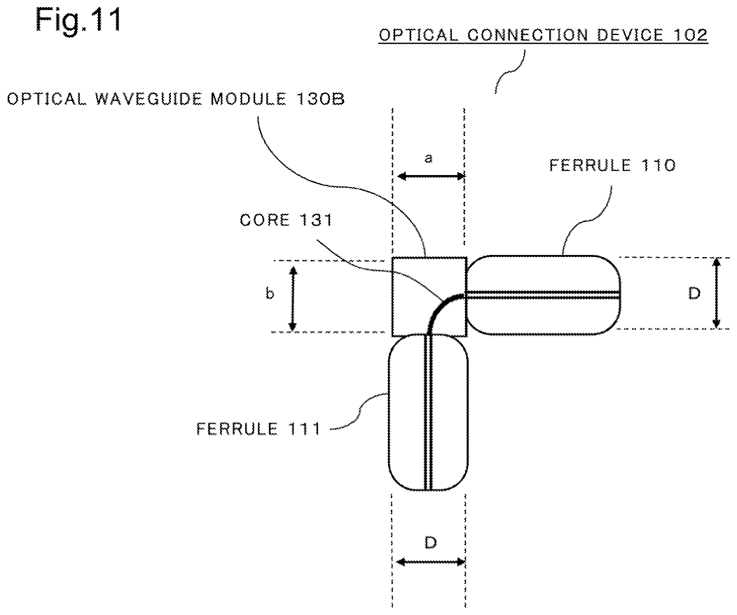

FIG. 11 is a diagram for describing a configuration example of an optical connection device 102 according to a third example embodiment. The optical connection device 102 includes ferrules 110 and 111 and an optical waveguide module 130B. Similarly to the optical waveguide module 130, the optical waveguide module 130B includes the core 131 having a bending portion at 90 degrees. Both the ends of the core 131 are connected to one end of the ferrule 110 and one end of the ferrule 111.

In the optical connection device 101, the ferrule 111 can be connected in the direction at the angle of 90 degrees with respect to the optical axis of the ferrule 110. The sizes of the two sides a and b of the optical waveguide module 130B may be larger than those of the optical waveguide module 130 for direct connection of the adjacent ferrules 110 and 111. In FIG. 11, the dimensions a and b of the surface on which the core of the optical waveguide module 130B is formed are substantially equivalent to the diameters D of the ferrules 110 and 111. However, a and b may be smaller than D as long as the ferrule 110 is not brought into contact with the ferrule 111. For example, the end surfaces of the ferrules 110 and 111 that are on sides close to the optical waveguide module 130B may be chamfered. With this, the core 131 of the optical waveguide module 130B can directly be brought into contact with the optical fiber wires of the ferrules 110 and 111 while further reducing a size of the optical waveguide module 130B.

The connection portion between the ferrule 110 and the optical waveguide module 130B and the connection portion between the ferrule 111 and the optical waveguide module 130B are both fixed after optical axis adjustment. An adhesive formed of a thermosetting resin or an ultraviolet light curable resin as a material is used for such fixation, for example. With the optical connection device 102 thus configured, a small-sized optical angle connector can also be achieved.

### (First Modification Example of Third Example Embodiment)

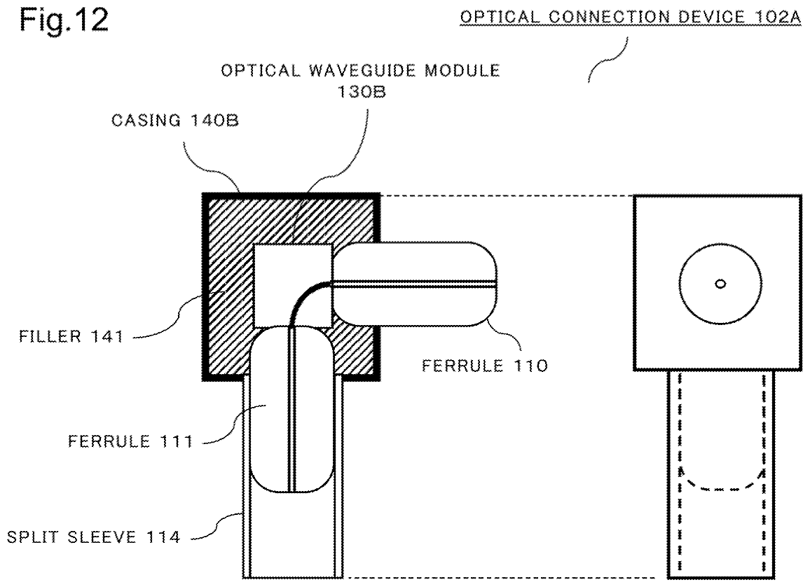

FIG. 12 is a diagram for describing a configuration example of an optical connection device 102A being a first modification example of the third example embodiment. In the optical connection device 102A, the ferrules 110 and 111 and the optical waveguide module 130B are covered with the one casing 140B. Further, a split sleeve 114 may be attached to the ferrule 111. The split sleeve 114 is used for optically connecting the ferrule 111 to a ferrule of another optical device. The split sleeve 114 may be attached to at least one of the ferrules 110 and 111.

Similarly to the example embodiments described above, the inside of the casing 140B is filled with the filler 141. The materials of the casing 140B and the filler 141 are not particularly limited. For example, the casing 140B is formed of metal or plastic. The filler 141 is, for example, a thermosetting resin or an ultraviolet light curable resin. The casing 140B may be attached in such a way to cover the optical waveguide module 130B after optical axis adjustment between the optical waveguide module 130B and the ferrules 110 and 111, and the inside of the casing 140B may be filled with the adhesive as the filler 141.

With this structure, the optical connection device 102A can reduce a risk of damage or optical axis deviation due to an external force because the ferrules 110 and 111 and the optical waveguide module 130B can firmly be integrated. As a result, the optical connection device 102A can improve reliability of the optical connection device 102. Further, in the optical connection device 102A, the split sleeve 114 facilitates connection to the ferrule of the other optical connector. Further, with the optical connection device 102A, a small-sized optical angle connector can also be achieved.

### (Second Modification Example of Third Example Embodiment)

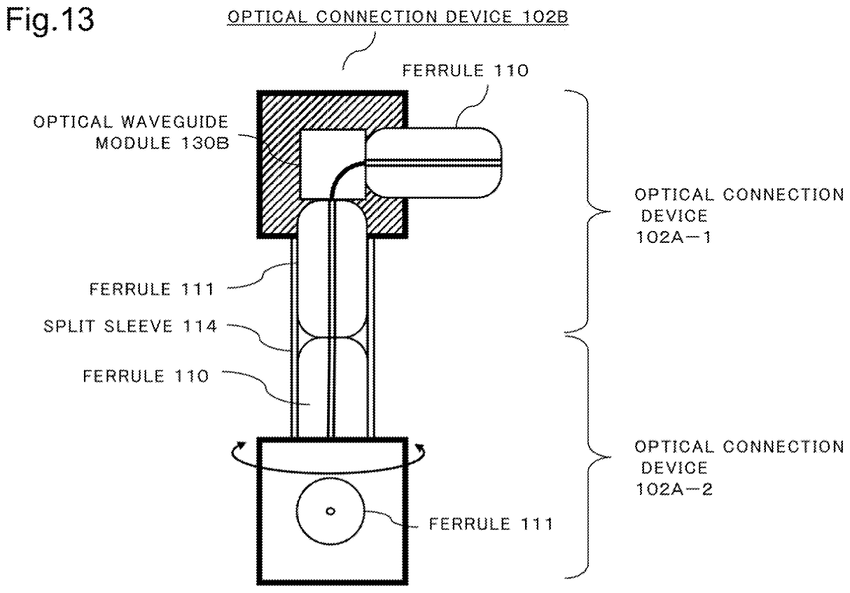

FIG. 13 is a diagram for describing an optical connection device 102B being a second modification example of the third example embodiment. In the optical connection device 102B in FIG. 13, optical connection devices 102A-1 and 102A-2 are directly connected to each other in series through use of the one split sleeve 114. the optical connection devices 102A-1 and 102A-2 include configurations similar to that of the optical connection device 102A. The optical connection device 102B may include the split sleeve 114 for a remaining ferrule.

The optical connection device 102A-1 and the optical connection device 102A-2 are rotatable about the center axis of the split sleeve 114. Therefore, in the optical connection device 102B, the angle formed between the ferrule 111 of the optical connection device 102A-1 and the ferrule 110 of the optical connection device 102A-2 can be changed. FIG. 13 illustrates a case in which the optical axis of the ferrule 110 of the optical connection device 102-1 is parallel to the paper sheet and the optical axis of the ferrule 111 of the optical connection device 102-2 is vertical to the paper sheet.

Alternatively, the optical axis of the ferrule 111 of the optical connection device 102A-1 and the optical axis of the ferrule 110 of the optical connection device 102A-2 may not be on the same linear line, and may be parallel to each other. With the optical connection device 102B thus configured, a small-sized optical angle connector capable of changing an optical axis on a plane to an optical axis on a different plane (in other words, capable of performing three-dimensional change) can be achieved. Further, the optical connection devices 102A-1 and 102A-2 are connected to each other, and thus the optical connection device 102B may be referred to as a composite optical connection device. Here, the optical connection device 102A-1 may be referred to as a first optical connection device, and the optical connection device 102A-2 may be referred to as a second optical connection device.

### Fourth Example Embodiment

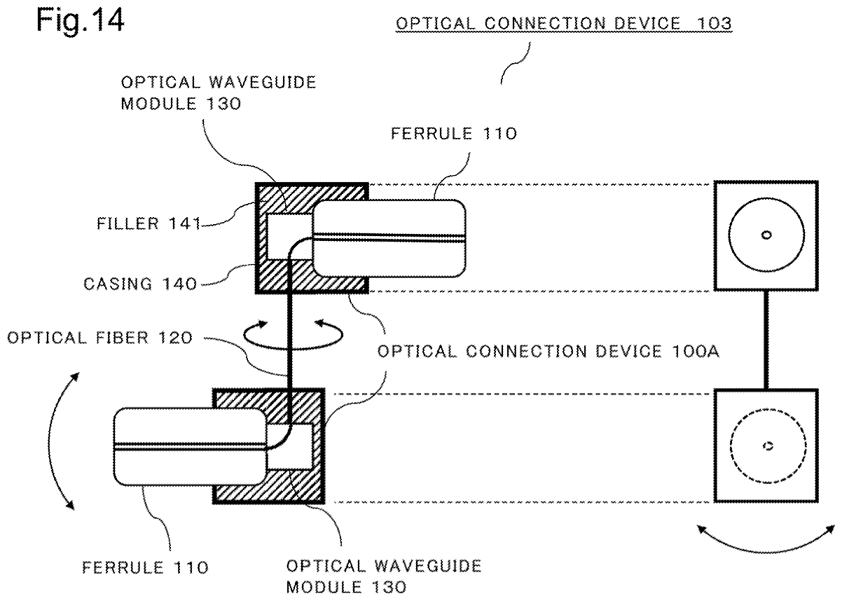

FIG. 14 is a diagram for describing a configuration example of an optical connection device 103 according to a fourth example embodiment. In the optical connection device 103, the ferrule 110, the optical waveguide module 130, and the casing 140 are provided to each end of the optical fiber 120 of the optical connection device 100A illustrated in FIG. 5. The optical connection device 103 may be configured by connecting the optical fibers 120 of the two optical connection devices 100A to each other by splicing or the like. The optical connection device 103 is configured by connecting the two optical connection devices 100A to each other, and hence may be referred to as a composite optical connection device.

In the optical connection device 103 thus configured, the two ferrules 110 are connected by the optical fiber 120 having flexibility. Similarly to the optical connection device 102B, with the optical connection device 103, a small-sized optical angle connector capable of changing an optical axis on a plane to an optical axis on a different plane can be achieved. Further, as compared to the optical connection device 102B according to the third example embodiment, the optical connection device 103 exerts an effect that the angle and the positional relationship between the two ferrules 110 can be set freely within a range of the bending amount allowed for the optical fiber 120.

### Fifth Example Embodiment

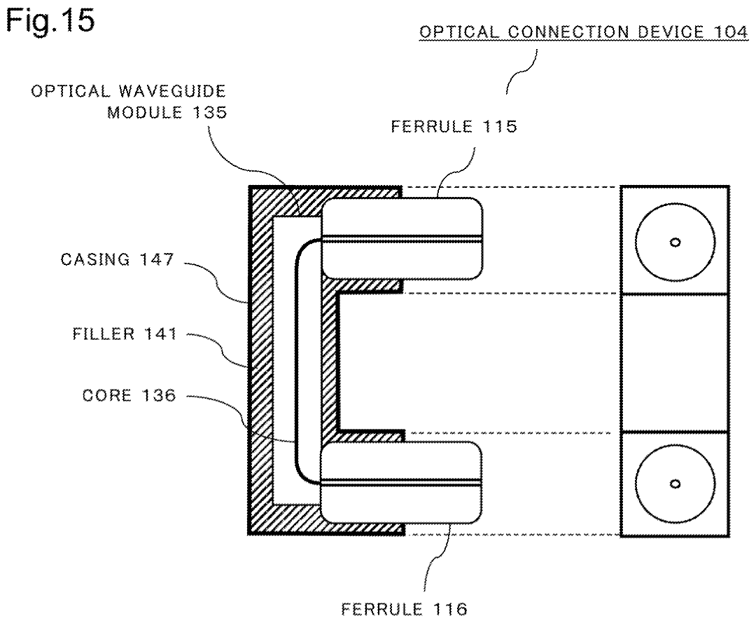

FIG. 15 is a diagram for describing a configuration example of an optical connection device 104 according to a fifth example embodiment. The optical connection device 104 includes ferrules 115 and 116, an optical waveguide module 135, and a casing 147. The optical waveguide module 135 connects one end of the ferrule 115 and one end of the ferrule 116 to each other. The ferrules 115 and 116 are arranged in parallel. Thus, a core 136 of the optical waveguide module 135 have two bending portions at 90 degrees. Further, the ferrules 115 and 116 are inserted into two optical receptacles arranged in parallel, and thus those receptacles can optically be connected to each other in the optical connection device 104.

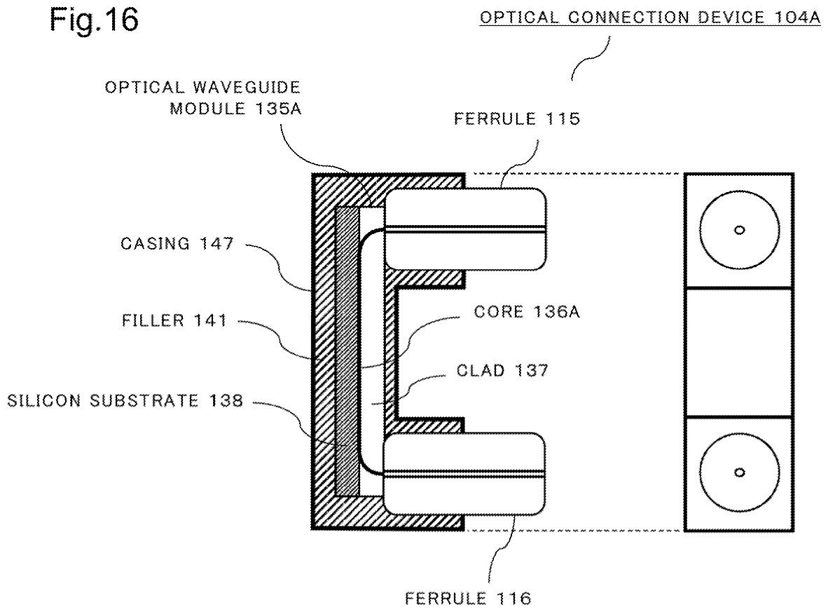

FIG. 16 is a diagram for describing a modification example of the optical connection device 104 according to the fifth example embodiment. An optical connection device 104A includes an optical waveguide module 135A, in place of the optical waveguide module 135 of the optical connection device 104. The optical waveguide module 135A has a configuration in which a core 136A and a clad 137 are formed on a silicon substrate 138. Similarly to the core 231 of the optical waveguide module 230 described in FIG. 3, both the ends of the core 136A are curved in a direction vertical to the silicon substrate 138. Similarly to the optical connection device 104, in the optical connection device 104A thus configured, two optical receptacles arranged in parallel can optically be connected to each other.

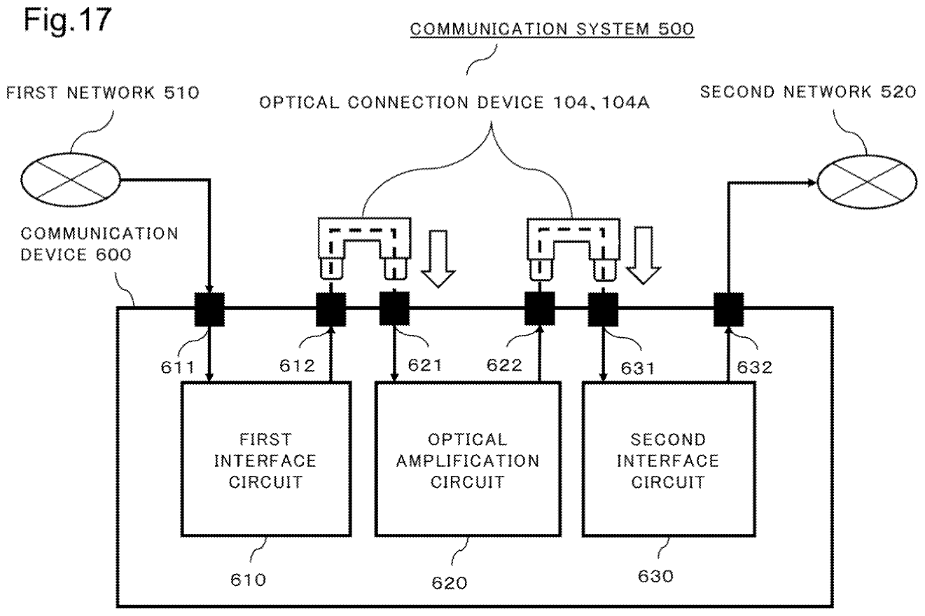

FIG. 17 is a diagram for describing an application example of the optical connection devices 104 and 104A. A communication system 500 is an optical transmission system including a first network 510, the second network 520, and a communication device 600. The communication device 600 includes a first interface circuit 610, an optical amplification circuit 620, and a second interface circuit 630. The first network 510 is connected to an optical interface 611, and the second network 520 is connected to an optical interface 612 or 632. The communication device 600 is an optical communication device installed in a station building on the land, for example. The first network 510 is, for example, a land network, and the second network is, for example, a submarine cable network.

The communication device 600 includes optical interfaces 611, 612, 621, 622, 631, and 632 as interfaces to the outside. Those interfaces are optical receptacles included on a front surface or a rear surface of the communication device 600.

The first interface circuit 610 converts an optical signal, which is input from the first network 510 to the optical interface 611, in such a way to be processed in the communication device 600, and outputs the converted optical signal to the optical interface 612. The optical amplification circuit 620 amplifies the light input from the optical interface 621, and outputs the amplified light to the optical interface 622. The second interface circuit 630 converts an optical signal, which is input to the optical interface 631, in such a way to be transmitted via the second network 520, and outputs the converted optical signal to the optical interface 632. The first interface circuit and the second interface circuit adjust intensity or a spectrum of the input light by using an optical attenuator or an optical filter.

According to the specification of the communication system 500, the optical amplification circuit 620 may be used or may not be used in some cases. When the optical amplification circuit 620 is not used, the optical interface 612 is directly connected to the optical interface 631 being the second interface circuit. When the optical amplification circuit 620 is used, the optical amplification circuit 620 amplifies an output of the first interface circuit 610, and outputs the resultant to the second interface circuit 630. In this case, by optically connecting the optical interfaces 612 and 621 to each other and optically connecting the optical interfaces 622 and 631 to each other, the communication device 600 is capable of amplifying the light input from the first network 510 and outputting the amplified light to the second network 520.

In general, an optical fiber (patch cord, patch cable) including optical connectors at both the ends is used for connection between the optical interfaces 612 and 621 and connection between the optical interfaces 622 and 631. The optical interfaces 612, 621, 622, and 631 are optical receptacles installed on the side surface of the communication device 600. Thus, when the general patch cord is connected to those optical receptacles, a restriction of a minimum bending radius of the optical fiber increases a floor area required for installation of the communication device 600. Here, the interval between the ferrules of the optical connection device 104 or 104A can match with the interval between the optical interface 612 and the optical interface 621. With this configuration, the optical connection device 104 or 104A can be inserted into the optical receptacle of the optical interfaces 612 and 621. Similarly, the optical interfaces 622 and 631 can be connected to each other through use of the optical connection device 104 or 104A. FIG. 17 illustrates that the optical connection device 104 or 104A is inserted into the optical receptacles of the optical interfaces 612, 621, 622, and 631 in the directions as indicated with the arrows.

The optical connection device 104 is used for connection between the optical interfaces provided to the communication device 600, and thus the two optical interfaces can be connected to each other in an occupied area smaller than that in a case in which a general optical fiber provided with a connector. In other words, with the optical connection device 104, a small-sized optical angle connector can be achieved, and hence an accommodation efficiency of the communication device 600 in a station building can be improved.

When the interval between the two ferrules and the interval between the two optical receptacles match with each other, the two optical interfaces may be connected to each other by using the optical connection device 102B or the optical connection device 103, in place of the optical connection device 104.

The present disclosure provides an optical connection device, a composite optical connection device, and a manufacturing method of an optical connection device that achieve a small-sized optical angle connector.

The example embodiments of the disclosure of the present application may be described as in the following supplementary notes, but are not limited thereto.

### (Supplementary Note 1)

An optical connection device including:
a first optical component having a first optical axis;
a second optical component having a second optical axis different from the first optical axis; and
a silicon optical waveguide module including a silicon optical waveguide having a bending shape for changing a direction of the first optical axis to a direction of the second optical axis, and being connected to each of the first optical component and the second optical component.

### (Supplementary Note 2)

The optical connection device according to Supplementary Note 1, wherein
the silicon optical waveguide module is fixed under a state in which one end of the silicon optical waveguide and the first optical axis are optically coupled to each other, and is fixed under a state in which another end of the silicon optical waveguide and the second optical axis are optically coupled to each other.

### (Supplementary Note 3)

The optical connection device according to Supplementary Note 2, further including
a lens included in at least one of a first position and a second position,
   wherein
the first position is between the first optical component and the one end of the silicon optical waveguide, and the second position is between the second optical component and the another end of the silicon optical waveguide.

### (Supplementary Note 4)

The optical connection device according to any one of Supplementary Notes 1 to 3, wherein
an angle formed between the first optical axis and the second optical axis is 35 degrees or larger and 100 degrees or smaller.

### (Supplementary Note 5)

The optical connection device according to any one of Supplementary Notes 1 to 3, wherein the first optical axis and the second optical axis are not on the same linear line, and are parallel to each other.

### (Supplementary Note 6)

The optical connection device according to any one of Supplementary Notes 1 to 3, wherein
an angle formed between the first optical axis and the second optical axis is fixed.

### (Supplementary Note 7)

The optical connection device according to any one of Supplementary Notes 1 to 3, wherein
the first optical component is a ferrule, and the second optical component is any one of a ferrule and an optical fiber.

### (Supplementary Note 8)

A composite optical connection device including a first optical connection device and a second optical connection device each being the optical connection device according to any one of Supplementary Notes 1 to 3, wherein
the second optical component of the first optical connection device and the second optical component of the second optical connection device are connected to each other via an optical transmission path.

### (Supplementary Note 9)

The composite optical connection device according to Supplementary Note 8, wherein
the optical transmission path includes any one of a ferrule, an optical waveguide module, and an optical fiber.

### (Supplementary Note 10)

A manufacturing method of an optical connection device, including connecting, to each one of a first optical component having a first optical axis and a second optical component having a second optical axis different from the first optical axis, a silicon optical waveguide module including a silicon optical waveguide having a bending shape for changing a direction of the first optical axis to a direction of the second optical axis.

### (Supplementary Note 11)

The manufacturing method of an optical connection device according to Supplementary Note 10, comprising:
fixing one end of an optical axis of the silicon optical waveguide module and the first optical axis to each other under an optically coupled state; and
fixing another end of the optical axis of the silicon optical waveguide module and the second optical axis to each other under an optically coupled state.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

Further, the configurations described in the example embodiments are not necessarily exclusive from one another. The actions and the effects of the present disclosure may be achieved by a configuration acquired by combining all or some of the example embodiments described above.

### REFERENCE SIGNS LIST

100, 100A, 100B, 100C Optical connection device
101, 101A, 102, 102A, 102A-1, 102A-2 Optical connection device
102B, 103, 104, 200 Optical connection device
110, 111, 115, 116 Ferrule
112 Fiber hole
113 Optical fiber wire
114 Sleeve
120 Optical fiber
130, 130A, 130B, 135, 135A, 230 Optical waveguide module
131, 131A, 136, 136A, 231 Core
132, 137, 232 Clad
133, 138, 233 Silicon substrate
135 Optical waveguide module
140, 140A, 140B, 142, 147 Casing
141 Filler
500 Communication system
510 First network
520 Second network
600 Communication device
610 First interface circuit
611, 612, 621, 622, 631, 632 Optical interface
620 Optical amplification circuit

1. An optical connection device comprising:
a first optical component having a first optical axis;
a second optical component having a second optical axis different from the first optical axis; and
a silicon optical waveguide circuit including a silicon optical waveguide having a bending shape for changing a direction of the first optical axis to a direction of the second optical axis, and being connected to each of the first optical component and the second optical component.

2. The optical connection device according to claim 1, wherein
the silicon optical waveguide circuit
is fixed under a state in which one end of the silicon optical waveguide and the first optical axis are optically coupled to each other, and
is fixed under a state in which another end of the silicon optical waveguide and the second optical axis are optically coupled to each other.

3. The optical connection device according to claim 2, further comprising
a lens included in at least one of a first position and a second position,
wherein
the first position is between the first optical component and the one end of the silicon optical waveguide, and the second position is between the second optical component and the another end of the silicon optical waveguide.

4. The optical connection device according to claim 1, wherein
an angle formed between the first optical axis and the second optical axis is 35 degrees or larger and 100 degrees or smaller.

5. The optical connection device according to claim 2, wherein
an angle formed between the first optical axis and the second optical axis is 35 degrees or larger and 100 degrees or smaller.

6. The optical connection device according to claim 1, wherein
the first optical axis and the second optical axis are not on the same linear line, and are parallel to each other.

7. The optical connection device according to claim 2, wherein
the first optical axis and the second optical axis are not on the same linear line, and are parallel to each other.

8. The optical connection device according to claim 1, wherein
an angle formed between the first optical axis and the second optical axis is fixed.

9. The optical connection device according to claim 2, wherein
an angle formed between the first optical axis and the second optical axis is fixed.

10. The optical connection device according to claim 1, wherein
the first optical component is a ferrule, and the second optical component is any one of a ferrule and an optical fiber.

11. The optical connection device according to claim 2, wherein
the first optical component is a ferrule, and the second optical component is any one of a ferrule and an optical fiber.

12. A composite optical connection device comprising:
a first optical connection device including
a first optical component having a first optical axis,
a second optical component having a second optical axis different from the first optical axis, and
a silicon optical waveguide circuit including a silicon optical waveguide having a bending shape for changing a direction of the first optical axis to a direction of the second optical axis, and being connected to each of the first optical component and the second optical component; and
a second optical connection device including a configuration identical to that of the first optical connection device, wherein
the second optical component of the first optical connection device and the second optical component of the second optical connection device are connected to each other via an optical transmission path.

13. The composite optical connection device according to claim 12, wherein
the optical transmission path includes any one of a ferrule, an optical waveguide circuit, and an optical fiber.

14. A manufacturing method of an optical connection device, comprising
connecting, to each one of a first optical component having a first optical axis and a second optical component having a second optical axis different from the first optical axis, a silicon optical waveguide circuit including a silicon optical waveguide having a bending shape for changing a direction of the first optical axis to a direction of the second optical axis.

15. The manufacturing method of an optical connection device according to claim 14, comprising:
fixing one end of an optical axis of the silicon optical waveguide circuit and the first optical axis to each other under an optically coupled state; and
fixing another end of the optical axis of the silicon optical waveguide circuit and the second optical axis to each other under an optically coupled state.
